(19) United States
(12) Patent Application Publication
(10) Pub. No.: US 2014/0101046 A1
(43) Pub. Date: Apr. 10, 2014

(54) SYSTEM AND METHOD FOR ONLINE FINANCIAL TRANSACTIONS

(71) Applicant: AMERICAN EXPRESS TRAVEL RELATED SERVICES COMPA, New York, NY (US)

(72) Inventor: Michael D. O'Connor, Scottsdale, AZ (US)

(73) Assignee: American Express Travel Related Services Company, Inc., New York, NY (US)

(21) Appl. No.: 13/648,066

(22) Filed: Oct. 9, 2012

(51) Int. Cl. G06Q 20/40

(52) U.S. Cl. 705/44

(57) ABSTRACT

Systems, methods, and articles of manufacture capable of approving financial transactions are disclosed. An on-line merchant may store consumer transaction account information. The merchant may transmit an authorization request with an indicator that indicates that a consumer has logged into their account. A transaction account issuer may detect the indicator and determine that the authorization request has a lower fraud risk. The transaction account issuer may approve the authorization request and transmit an authorization response to the merchant.

### FIELD

The present disclosure relates to financial transactions, and more specifically to approving financial transactions performed using a transaction account.

### BACKGROUND

Online commerce has grown tremendously in recent past. Online commerce includes online financial transactions. The online financial transactions may be performed to accomplish online purchase of goods or services using a transaction account. A consumer visits an online portal, an online store, or an online shopping mall for online purchase of goods or services. The consumer selects the goods or services for purchase and places an order for the same. The consumer pays for the order using a transaction account, for example, a credit card. After the order has been placed by the consumer and payment has been confirmed by the merchant, delivery of goods or services is made to the consumer.

Typically, the consumer enters transaction account information associated with the transaction account, such as, a transaction account number, name of a transaction account holder, an expiration date, a transaction security code, etc., during an online purchase. The merchant provides the transaction account information to a transaction account issuer in an authorization request for approving the transaction. The transaction account issuer verifies the transaction account information and approves the authorization request when the transaction account information matches with previously stored transaction account information for that consumer. However, many consumers find the process of entering the transaction account information for every transaction cumbersome, leading to degradation in the consumer experience.

Consumers are increasingly preferring to provide their transaction account information only once to the merchant and perform transactions seamlessly each time they make an online purchase through the merchant website. As the consumers had already provided the transaction account information for performing the transaction, the consumers are now required only to press a buy button available at the merchant website against good(s) or service(s) he wishes to buy.

Though such transactions are very convenient to the consumer and the merchant, they may carry significant risks of fraud. Government and other regulations do not permit the merchant to store the transaction account security code. Therefore, the merchant does not transmit the transaction account security code to the transaction account issuer. The transaction account issuer, however, expects to see the transaction account security code to differentiate between genuine and fraudulent transactions. Many transaction account issuers simply reject an authorization request if the transaction account security code is not provided. The rejection of the authorization request results in inconvenience to the consumer, and loss of business to the merchant, the transaction account issuer and all intervening parties in transaction chain. On the other hand, if a transaction account issuer approves an authorization request having no transaction security code, the transaction account issuer may be exposed to significant risks of fraud.

Given the foregoing, there is a need for systems and methods which increase the rate of approvals of financial transactions, and at the same time reduce the risk of fraudulent transactions.

### SUMMARY

Systems, methods, and articles of manufacture for approving financial transactions are disclosed. A method may include analyzing an authorization request associated with a transaction account and detecting an indicator in the authorization request indicating that a merchant has authenticated verification information associated with the transaction account. The merchant may store transaction account information associated with the transaction account, and the verification information may include a user name and password. The authorization request may include the indicator in place of an account security code. The method may include transmitting an authorization response to the merchant.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure. For a better understanding of the aspects of the disclosure presented herein, together with other and further features and advantages thereof, reference is made to the following description, taken in conjunction with the accompanying drawings.

### BRIEF DESCRIPTION OF THE DRAWINGS

The above and other advantages of the disclosure will be apparent upon consideration of the following detailed description, taken in conjunction with the accompanying drawings, in which like reference characters refer to like parts throughout, and in which:

FIG. 1 illustrates a network environment for a system for online financial transactions according to various embodiments of the disclosure;

FIG. 2 illustrates a system for online financial transactions according to various embodiments;

FIG. 3 is a flowchart which illustrates a method for online financial transactions according to various embodiments; and

FIG. 4 illustrates a block diagram of a computer system for implementing the online financial transaction system according to various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure discloses methods, systems and articles of manufacture for performing secure online financial transactions. Some of the terms used in the description are explained below.

The phrases consumer, customer, user, account holder, account affiliate, cardmember or the like shall include any person, entity, business, government organization, business, software, hardware, or machine associated with a transaction account, that buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

A “merchant acquirer” is an entity which processes financial transactions performed using transaction accounts on behalf of the merchant.

The consumers may perform transactions with the merchants using one or more transaction accounts. Examples of the transaction account include, but are not limited to, credit cards, debit cards, pre-paid cards, charge cards, gift cards and the like. The transaction accounts may be issued by a transaction account issuer, for example, American Express.

The terms “products”, “services” and the like have been used interchangeably in this disclosure and may refer to any kind of service or product offered by a merchant.

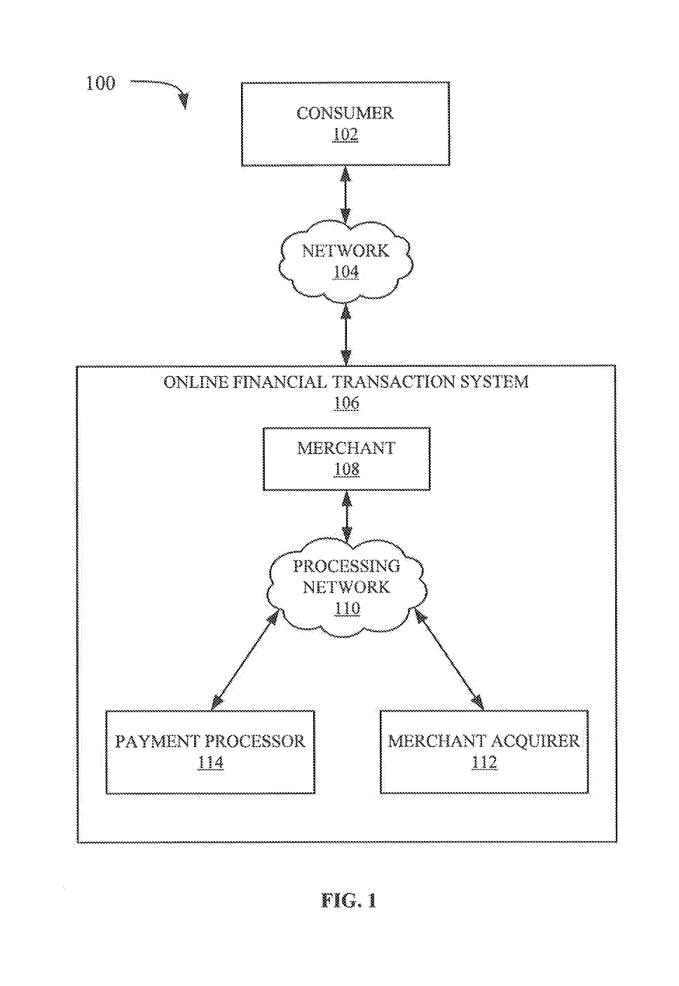

With reference to FIG. 1, in various embodiments, a network environment 100 may include a consumer 102 communicably coupled to an online financial transaction system 106 (hereinafter interchangeably referred to as the system 106) through a network 104. The network 104 may be a wide area network (WAN), a local area network (LAN), an Ethernet, Internet, an Intranet, a cellular network, a satellite network, or any other suitable network for transmitting data. In various embodiments, the network 104 may include a combination of two or more of the aforementioned networks and/or other types of networks known in the art. The network 104 may be implemented as a wired network, a wireless network or a combination thereof. It should be appreciated that other types of networks are also contemplated herein. Further, data transmission between the consumer 102 and the system 106 may occur over the network 104, in an encrypted or otherwise secure format, in any of a wide variety of known manners.

The consumer 102 may interact with the system 106 for making an online purchase of good(s) and/or service(s). The system 106 may include a merchant 108, a processing network 110, a merchant acquirer 112, and a payment processor 114. The processing network 110 may be a virtual private network running over the network 104, according to various embodiments. According to various embodiments, the processing network 110 may be Internet, an intranet, a LAN, a WAN, or any other suitable network capable of processing financial transactions. The consumer 102 may interact with various elements of the system 106 using a consumer device. The consumer device may include suitable hardware and/or software for interacting with the system 106. Examples of the consumer devices may include, without limitation, a personal computer, a laptop, a mobile phone, a portable device, a personal digital assistant and/or the like.

The merchant 108 may receive a transaction request from the consumer 102. The transaction request corresponds to the online purchase made by the consumer 102 with the merchant 108. The consumer 102 may create a consumer account with the merchant 108. The consumer 102 may be required to log in to the consumer account using suitable credentials before performing any transaction with the merchant 108. The credentials may include a user name and a password associated with the consumer account. Other examples of the credentials may include biometric information, personal information, such as, a social security number, a birth date, mother's maiden name, and/or any other suitable information. The consumer 102 may provide the credentials before, during or after creating the consumer account with the merchant 108. The merchant 108 may store the credentials in a database 216. Further, the merchant 108 may also store verification information associated with the consumer 102 and/or the transaction account of the consumer 102. The verification information may include one or more of a transaction account number, an expiration date, a billing address, a shipping address, an email address, a phone number, an IP address, a birth date, a social security number, a user name and a password, biometric information, etc. The merchant 108 may store the verification information in a database 216.

Upon receiving the transaction request, the merchant 108 may verify the verification information. The merchant 108 may generate an authorization request by associating an indicator with the transaction request. The indicator may signify that the merchant 108 has authenticated verification information associated with the transaction account. The verification information may comprise a password and a user name for the consumer 102. Using the verification information, the merchant 108 may verify authenticity of the consumer 102. In various embodiments, the value of the indicator may be unique to the merchant 108. In various embodiments, a single value of the indicator or a set of indicator values may be shared by a plurality of merchants.

In various embodiments, the merchant 108 may generate the indicator each time a transaction request is received. In various embodiments, the merchant 108 associates a pre-stored indicator with the transaction request. In various embodiments, the merchant 108 may request an indicator from the payment processor 114 and/or the merchant acquirer 112. In various embodiments, a score may be assigned to the indicator based on the fields stored by the merchant. The fields may include a transaction account number, an expiration date, a billing address, a shipping address, an email address, a phone number, an IP address, a birth date, a social security number, a user name and a password, biometric information, etc. The score may signify a number of information fields and/or values of the information fields. For example, certain fields, such as, the transaction account number, name of the consumer, the expiration date and the like may contribute more to the score assigned to the indicator than other fields, such as, the email address, the date of birth, etc.

The indicator may be a value (numerical or otherwise). Further, the indicator may include an algorithm indicating authentication of the verification information. For example, the algorithm may be a set of instructions for interpreting and/or decoding the value. In another example, the algorithm may specify an encryption scheme used to generate the value of the indicator. This encryption scheme may then be used by the transaction account issuer to decrypt the value of the indicator. The value of the indicator may be determined in a variety of ways by the merchant and/or the transaction account issuer. For example, the value of the indicator may be determined on the basis of number of information fields stored by the merchant in the consumer account information, the transaction account information, or the payment information associated with the transaction request. The value of the indicator may also vary with regulator guidelines to be followed in a jurisdiction. A high value of the indicator may imply a safer transaction request than a low value of the indicator. In various embodiments, the indicator may also indicate that the authorization request does not include a transaction account security code.

The indicator may be transmitted in any of fields in the authorization request. For example, the indicator may be transmitted in the transaction account security code field. In various embodiments, a new field may be created in the authorization request to transmit the indicator. In various embodiments, for better security, both the indicator and the transaction account security code may be included in the authorization request.

Other than the indicator, the authorization request may also include the transaction account information associated with the transaction account. The transaction account information may include, for example, one or more of a transaction account number, an expiration date, a billing address, a shipping address, an email address, a phone number, an IP address, a birth date, a social security number, a user name, and a password, etc.

A unique indicator may be assigned to the merchant 108 by the payment processor 114 prior to accepting any authorization request from the merchant 108. The merchant 108 may then include substantially the same indicator in all authorization requests and the payment processor 114 may compare the indicator with the pre-stored indicator for the merchant 108.

In various embodiments, the indicator may vary for every transaction request. The payment processor 114 (e.g., issuer) may send an indicator to the merchant 108 for processing each authorization request prior to receiving the authorization request. For example, the payment processor 114 may send such an indicator after approving an authorization request from the merchant 108 such that the merchant 108 can use the sent indicator for a subsequent authorization request. The merchant 108 sends the indicator back to confirm that the consumer has been verified. Further, a code may be exchanged between the merchant 108 and the payment processor 114 instead of the indicator.

The merchant 108 may transmit the authorization request to the merchant acquirer 112. The merchant acquirer 112 may be an entity which processes financial transactions performed using transaction accounts on behalf of the merchant 108. For example, the merchant acquirer 112 accepts payment on behalf of the merchant 108 in a merchant account and later pays to the merchant 108 after deducting a processing fee. A plurality of merchants 108 may have their merchant accounts with the merchant acquirer 112. The merchant acquirer 112 may transmit the authorization request with the accompanying indicator to the processing network 110. The merchant acquirer 112 may transmit the authorization request to the processing network 112. In various embodiments, the processing network 110 is owned by the merchant acquirer 112. In various embodiments, the processing network 110 is owned by the payment processor 114. In various embodiments, the processing network 110 may be owned by a third party. The processing network 110 provides a communication link between a plurality of merchant acquirers and a plurality of transaction account issuers. The processing network 112 may resolve network related activities and transmit the authorization request to the payment processor 114.

The payment processor 114 may analyze the authorization request. The payment processor 114 may detect whether the indicator is present in the authorization request. The detection may comprise locating a flag, a tag, a number, a code or any other data that provides such information. The detection may be by the payment processor 114 or any other entity or system. For example, the other entity may send the results of the detection to the payment processor 114. The indicator may signify (e.g., based on the type of indicator, the information associated with the indicator, a look-up table, etc) to the payment processor 114 that the merchant 108 has authenticated verification information associated with the transaction account. In various embodiments, the payment processor 114 may determine based on the indicator that the merchant 108 is authorized to transmit the authorization request without a transaction account security code. The payment processor 114 may transmit, based on the indicator, an authorization response to the merchant 108. In various embodiments, the payment processor 114 may approve the authorization request, in response to the score assigned to the indicator being above a predetermined threshold. The threshold may be determined based on the information relating to identity of the consumer is stored by the merchant 108. For example, information fields A, B, and C may be necessary for reaching the threshold score. If any of the information fields A, B, and C are absent, then other information fields even when combined may not reach the threshold score. During processing of the authorization request, the payment processor 114 may compare the indicator present in the authorization request to the indicator previously provided to the merchant 108. If matching fails, the authorization request may be rejected.

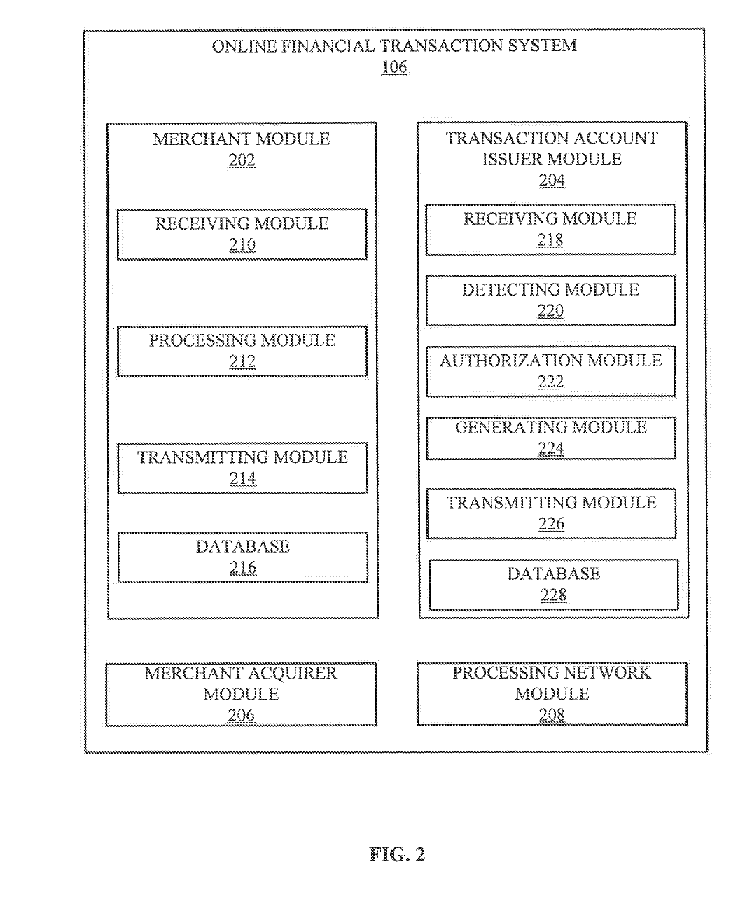

FIG. 2 illustrates a functional block diagram of the system 106, in accordance with various embodiments of the present disclosure. The system 106 may include a merchant module 202, a transaction account issuer module 204, a merchant acquirer module 206, and a processing network module 208. In various embodiments, the merchant module 202, the transaction account issuer module 204, the merchant acquirer module 206, the processing network module 208 are deployed, respectively, at the merchant 108, the payment processor 114, the merchant acquirer 112, and the processing network 110. A person skilled in the art will appreciate that the above and other modules may be deployed in variation to the above configuration as per the requirements of desired implementation; the variation being in the spirit and scope of the present disclosure.

The merchant module 202 may include a receiving module 210, a processing module 212, a transmitting module 214, and a database 216.

The receiving module 210 may receive communications targeted at the merchant 108. The communications may be targeted at the merchant 108 by the consumer 102, the merchant acquirer 112, the processing network 110 and/or the payment processor 114. The receiving module 210 may be capable of receiving wired as well as wireless communication. The receiving module 210 may be further capable of receiving communications from a platform different from the platform on which it is deployed. The receiving module 210 may be communicably coupled to the processing module 212.

The receiving module 210 may parse a transaction request submitted by the consumer 102. The receiving module 210 may transmit the parsed transaction request to the processing module 212.

The processing module 212 may process a parsed transaction request. The processing module 212 may authenticate the verification information associated with the transaction account. The verification information may comprise a password and a user name for the consumer 102. In response to the verification information being successfully authenticated, the processing module 212 may generate an indicator indicative of the authentication of the verification information.

In various embodiments, the indicator may be generated using transaction account information stored in the database 216. The transaction account information may include, for example, one or more of a transaction account number, an expiration date, a billing address, a shipping address, an email address, a phone number, an IP address, a birth date, a social security number, a user name, a password associated with the consumer 102. In various embodiments, the processing module 212 may associate a pre-stored indicator with the transaction request. In various embodiments, the processing module 212 may request an indicator from the payment processor 114. The processing module 212 may generate an authorization request based on the indicator and the parsed transaction request. The processing module 212 may generate an authorization request based on the transaction request and the indicator. The indicator may be transmitted by the processing module 212 as a value in any of the fields in the authorization request. For example, the indicator may be transmitted in the transaction account security field. Alternatively, a new field may be created in the authorization request to transmit the indicator.

The processing module 212 may forward the authorization request to the transmission module 214.

The transmission module 214 may be communicably coupled to the processing module 212 and the merchant acquirer module 206. The transmission module 214 may transmit the authorization request received from the processing module 212 to the merchant acquirer module 206. The transmission module 214 may transmit communications from the merchant 108. The communications may be targeted at the consumer 102, the merchant acquirer 112, the processing network 110 and/or the payment processor 114. The transmission module 214 may be capable of transmitting wired as well as wireless communication. The transmission module 214 may be further capable of transmitting communications to a platform different from the platform on which the transmission module 214 is deployed.

The merchant acquirer module 206 may receive the authorization request and forward the authorization request to the processing network module 208. The processing network module 208 may forward the authorization request to the transaction account issuer module 204.

The transaction account issuer module 204 may include a receiving module 218, a detecting module 220, an authorization module 222, a response generating module 224, a transmitting module 226 and a database 228.

The receiving module 218 may receive the authorization request from the processing network module 208 and forward the authorization request to the detecting module 220.

The detecting module 220 may detect the indicator in the authorization request. The detecting module 220 may indicate to the authorization module 222 that the authorization request is genuine as the merchant 108 has already verified the consumer 102.

The authorization module 222 may verify further details in the authorization request using the database 228. In various embodiments, the authorization module 222 may determine, based on the indicator, that the merchant 108 is authorized to transmit the authorization request without a transaction account security code. In various embodiments, the authorization module 222 may approve the authorization request in response to the score assigned to the indicator being above a predetermined threshold. The threshold may be determined depending upon consumer information to be stored by the merchant 108. In various embodiments, authorization module 222 may compare the indicator present in the authorization request to the indicator provided to the merchant 108. If matching fails, the authorization request may be rejected. The authorization module 222 may forward results of the verification to the generating module 224.

The generating module 224 may generate an authorization response based on the indicator and the verification results.

The transmitting module 226 may transmit the authorization response to the merchant 108 via processing network module 208 and the merchant acquirer module 206. In response to receiving the authorization response, the merchant 108 may process the transaction request received from the consumer 102.

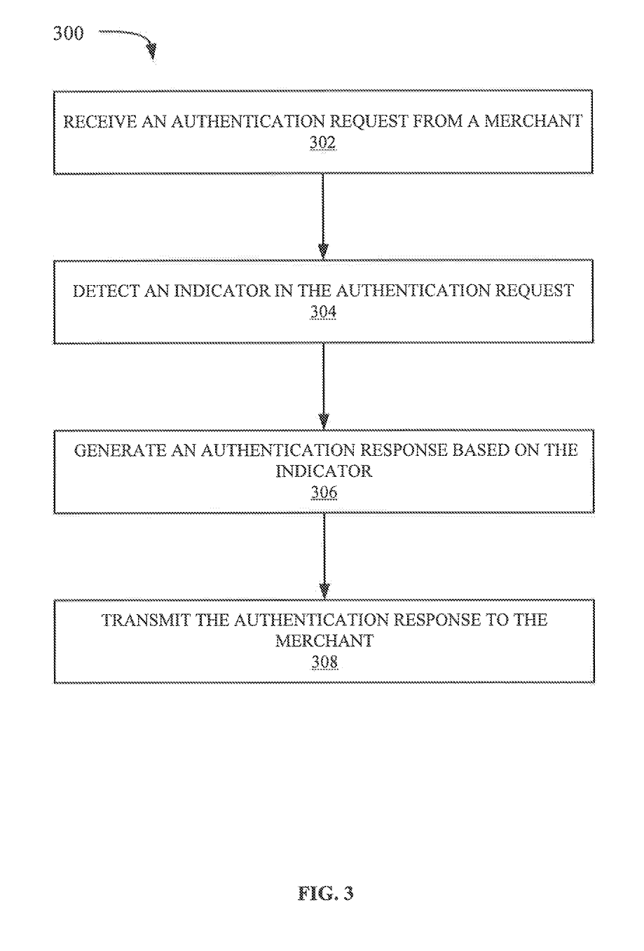

FIG. 3 is a flowchart illustrating a method of online financial transaction, in accordance with various embodiments of the present disclosure. An authorization request may be received from the merchant 108. (302). An indicator in the authorization request may be detected. (304). The indicator may indicate that the merchant 108 has authenticated verification information associated with a transaction account. An authorization response to the authorization request may be generated based on the indicator. (306). The authorization response may be transmitted to the merchant. (308).

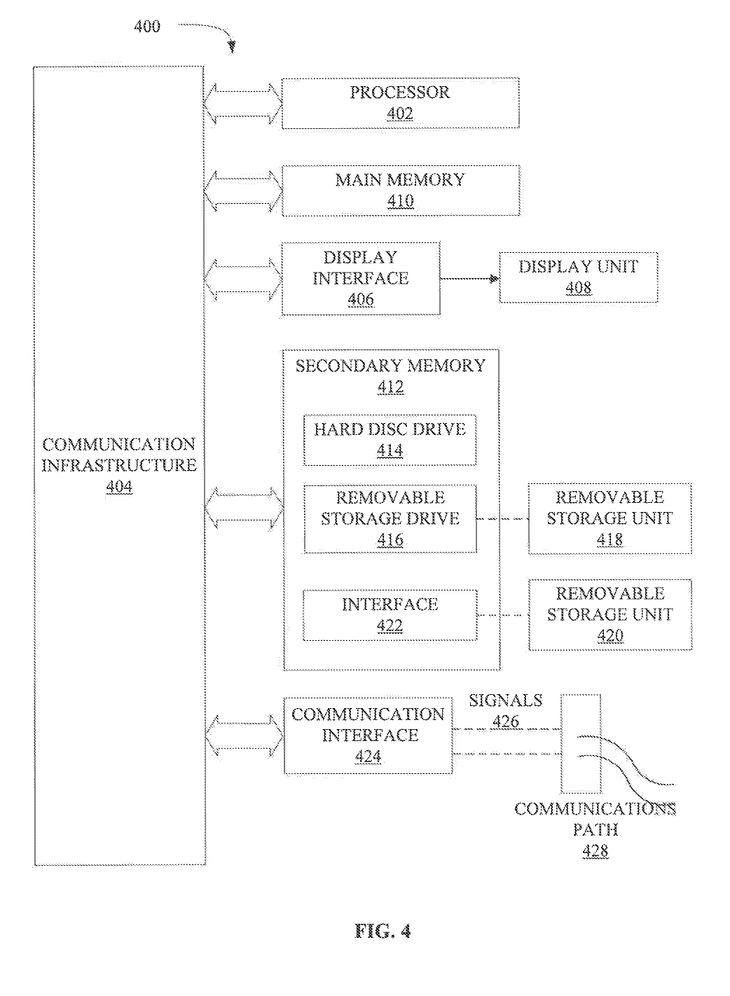

FIG. 4 illustrates a block diagram of a computer system 400 for implementing the online financial transaction system according to various embodiments. The computer system 400 includes at least one processor, such as a processor 402. Processor 402 is connected to a communication infrastructure 404, for example, a communications bus, a cross over bar, a network, and the like. Various software embodiments are described in terms of this exemplary computer system 400. After reading this description, it will become apparent to a person skilled in the relevant art(s) how to implement the present disclosure using other computer systems and/or architectures.

The computer system 400 includes a display interface 406 that forwards graphics, text, and other data from the communication infrastructure 404 (or from a frame buffer which is not shown in FIG. 4) for display on a display unit 408.

The computer system 400 further includes a main memory 410, such as random access memory (RAM), and may also include a secondary memory 412. The secondary memory 412 may further include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a well-known manner. The removable storage unit 418 may represent a floppy disk, magnetic tape or an optical disk, and may be read by and written on by the removable storage drive 416. As will be appreciated, the removable storage unit 418 includes a computer usable storage medium having stored therein, computer software and/or data.

In accordance with various embodiments of the present disclosure, the secondary memory 412 may include other similar devices for allowing computer programs or other instructions to be loaded into the computer system 400. Such devices may include, for example, a removable storage unit 420, and an interface 422. Examples of such devices may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from the removable storage unit 420 to the computer system 400.

The computer system 400 may further include a communication interface 424. The communication interface 424 allows software and data to be transferred between the computer system 400 and external devices. Examples of the communication interface 424 include, but may not be limited to a modem, a network interface (such as an Ethernet card), a communications port, a Personal Computer Memory Card International Association (PCMCIA) slot and card, and the like. Software and data transferred via the communication interface 424 are in the form of a plurality of signals, hereinafter referred to as signals 426, which may be electronic, electromagnetic, optical or other signals capable of being received by the communication interface 424. The signals 426 are provided to the communication interface 424 via a communication path (e.g., channel) 428. The communication path 428 carries the signals 426 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 416, a hard disk installed in hard disk drive 414, the signals 426, and the like. These computer program products provide software to the computer system 400. The present disclosure is directed to such computer program products.

Computer programs (also referred to as computer control logic) are stored in the main memory 410 and/or the secondary memory 412. Computer programs may also be received via the communication interface 404. Such computer programs, when executed, enable the computer system 400 to perform the features of the present disclosure, as discussed herein. In particular, the computer programs, when executed, enable the processor 402 to perform the features of the present disclosure. Accordingly, such computer programs represent controllers of the computer system 400.

In accordance with various embodiments of the present disclosure, where the present disclosure is implemented using a software, the software may be stored in a computer program product and loaded into the computer system 400 using the removable storage drive 416, the hard disk drive 414 or the communication interface 424. The control logic (software), in response to execution by the processor 402, causes the processor 402 to perform the functions of the present disclosure as described herein.

In various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s).

The diagrams in FIGS. 1-4 illustrate the architecture, functionality, and operation of possible implementations of systems, methods, and articles of manufacture according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present disclosure may be embodied as a method, system, or computer program product. Accordingly, the present disclosure may take the form of an entirely hardware embodiment, an entirely software embodiment (including firmware, resident software, micro-code, etc.) or various embodiments combining software and hardware aspects that may all generally be referred to herein as a “circuit,” “module” or “system.” Further, the present disclosure may take the form of a computer program product on a computer usable storage medium having computer-usable program code embodied in the medium. In various embodiments, the disclosure is implemented in software, which includes but is not limited to firmware, resident software, microcode, etc.

Further, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wire line, optical fiber cable, RF, etc.

Any suitable computer usable or computer readable medium may be utilized. The computer-usable or computer readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTube, AppleTV, Pandora, xBox, Sony Playstation), a uniform resource locator (“URL”), a document (e.g., a Microsoft Word document, a Microsoft Excel document, an Adobe .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel and/or the may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, Linkedn®, and the like. Examples of affiliate or partner websites include American Express®, Groupon®, LivingSocial®, and the like. Moreover, examples of mobile device communications include texting, email, and mobile applications for smartphones.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, or “cardmember” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant may be equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Phrases similar to a “payment processor” may include a company (e.g., a third party) appointed (e.g., by a merchant) to handle transactions. A payment processor may include an issuer, acquirer, authorizer and/or any other system or entity associated with or impacted by the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer implemented method comprising:
detecting, by a computer-based system for approving financial transactions, an indicator in an authorization request indicating that a merchant has authenticated verification information associated with a transaction account; and
transmitting, by the computer-based system and based on the indicator, an authorization response to the merchant.

2. The method of claim 1, further comprising determining, by the computer-based system, that the authorization request does not comprise a transaction account security code.

3. The method of claim 1, wherein the verification information comprises a password and user name for a consumer account associated with the merchant.

4. The method of claim 1, wherein the authorization request comprises an account number associated with the transaction account.

5. The method of claim 1, wherein the authorization request comprises an email address.

6. The method of claim 1, wherein the indicator comprises an algorithm indicating authentication of the verification information.

7. The method of claim 1, wherein the merchant stores transaction account information associated with the transaction account.

8. The method of claim 7, wherein the authorization request comprises the stored transaction account information.

9. The method of claim 1, further comprising determining, by the computer-based system and in response to detecting the indicator, that the merchant is authorized to transmit authorization requests without transaction account security codes.

10. The method of claim 1, wherein a value of the indicator indicates fields stored by the merchant.

11. The method of claim 10, wherein the fields comprise at least one of transaction account number, expiration date, billing address, shipping address, email address, phone number, IP address, birth date, social security number, user name, and password.

12. The method of claim 10, further comprising assigning, by the computer-based system, a score to the indicator, based upon the fields stored by the merchant.

13. The method of claim 12, further comprising approving, by the computer-based system, the authorization request in response to the score being above a predetermined threshold.

14. The method of claim 1, further comprising comparing, by the computer-based system, the indicator to a previously stored indicator for the merchant.

15. The method of claim 1, wherein the indicator is transmitted as a value in a transaction account security code field.

16. The method of claim 15, further comprising determining, by the computer-based system, that the value is substantially equal to a stored value corresponding to the merchant.

17. The method of claim 1, further comprising parsing, by the computer-based system, the authorization request to identify transaction information and the indicator.

18. The method of claim 1, further comprising:
transmitting, by the computer-based system and prior to receiving the authorization request, the indicator to the merchant, and
determining, by the computer-based system, that the indicator in the authorization request is substantially the same as the indicator transmitted to the merchant.

19. An article of manufacture including a non-transitory, tangible computer readable storage medium having instructions stored thereon that, in response to execution by a computer-based system for approving financial transactions, cause the computer-based system to perform operations comprising:
detecting, by the computer-based system, an indicator in an authorization request indicating that a merchant has authenticated verification information associated with a transaction account; and
transmitting, by the computer-based system and based on the indicator, an authorization response to the merchant.

20. A system comprising:
a processor for approving financial transactions,
a tangible, non-transitory memory configured to communicate with the processor,
the tangible, non-transitory memory having instructions stored thereon that, in response to execution by the processor, cause the processor to perform operations comprising:
detecting, by the processor, an indicator in an authorization request indicating that a merchant has authenticated verification information associated with a transaction account; and
transmitting, by the processor and based on the indicator, an authorization response to the merchant.
